(19) United States
(12) Patent Application Publication
(10) Pub. No.: US 2017/0295832 A1
(43) Pub. Date: Oct. 19, 2017

(54) MEAT FLAVOR INJECTOR

(71) Applicant: Abdias Paul, Flowery Branch, GA (US)

(72) Inventor: Abdias Paul, Flowery Branch, GA (US)

(21) Appl. No.: 15/486,209

(22) Filed: Apr. 12, 2017

Related U.S. Application Data
(60) Provisional application No. 62/323,854, filed on Apr. 18, 2016.

(51) Int. Cl. A23L 13/70; A47J 43/16

(52) U.S. Cl. CPC A23L 13/70; A47J 43/16; A23V 2002/00

(57) ABSTRACT

Implementations of a meat flavor injector are provided. In some implementations, the meat flavor injector comprises a container having an outer surface defining an open enclosure for holding content placed in the container, a lid configured to cover the open enclosure, and a plurality of hollow projections extending from the container wherein each of the hollow elongated projections comprises a proximal end and a distal end with an opening extending from the proximal end to the distal end and wherein distal of ends of the hollow elongated projections are pointed.

### CROSS REFERENCE TO RELATED APPLICATION

This application claims the benefit of U.S. Patent Application Ser. No. 62/323,854, which was filed on Apr. 18, 2016, and is incorporated herein by reference in its entirety.

### TECHNICAL FIELD

This disclosure relates to implementations of a meat flavor injector.

### BACKGROUND

When meat, such as turkey, chicken, pot roast, or pork, is cooked, it tends to become dry and lose its flavor. The cooking depletes the natural juices of the meat, which reduces its moistness and flavor. Existing techniques to keep meats moist and flavorful when cooked, such as basting, are typically time consuming, labor intensive, and ineffective.

### BRIEF DESCRIPTION OF THE DRAWINGS

FIGS. 1A and 1B illustrate an example implementation of a meat flavor injector according to the present disclosure.

### DETAILED DESCRIPTION

Implementations of a meat flavor injector are provided. In some implementations, the meat flavor injector comprises a container having an outer surface defining an open enclosure for holding content placed in the container, a lid configured to cover the open enclosure, and a plurality of hollow projections extending from the container wherein each of the hollow elongated projections comprises a proximal end and a distal end with an opening extending from the proximal end to the distal end and wherein distal of ends of the hollow elongated projections are pointed.

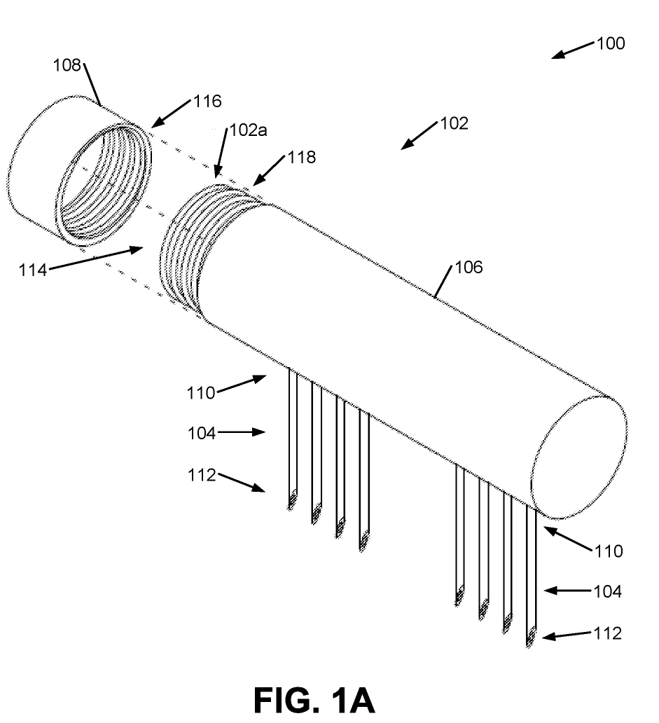

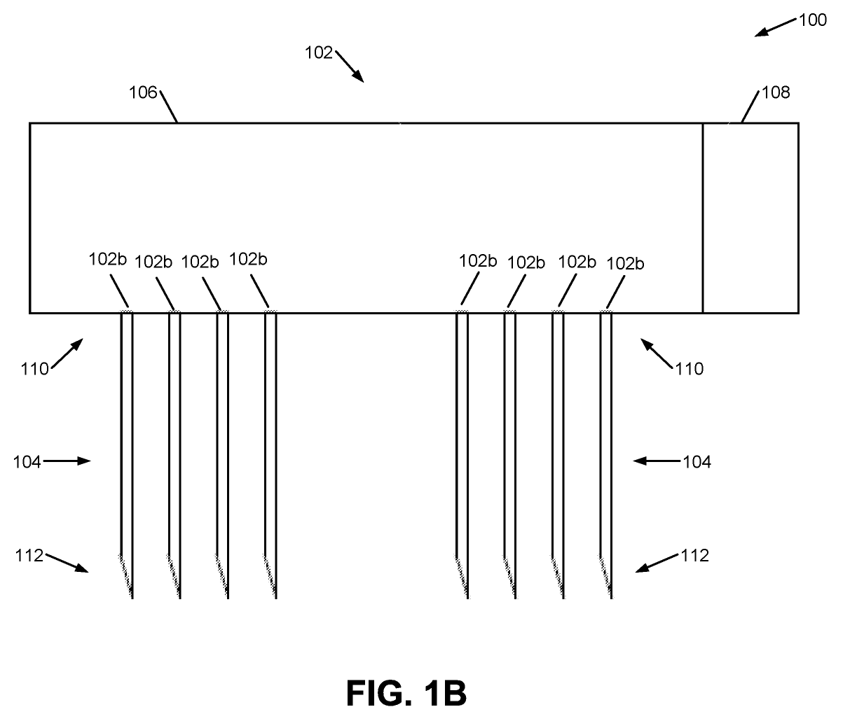

FIGS. 1A and 1B illustrate an example implementation of a meat flavor injector 100 according to the present disclosure. FIG. 1A is a prospective view of the meat flavor injector 100. FIG. 1B is a side view of the meat flavor injector 100 of FIG. 1A.

In some implementations, the meat flavor injector 100 comprises a container 102 having a lid 108 and a plurality of hollow elongated projections 104 extending from the container.

In some implementations, the container 102 comprises an outer surface 106 defining an open enclosure 114 for holding content placed in the container 102. In some implementations, the container 102 is elongated. In some implementations, the container 102 is cylindrical. In some implementations, the container 102 is any suitable shape.

In some implementations, the container 102 may be two inches to five inches long. In some implementations, the container 102 may be smaller than two inches long. In some implementations, the container 102 may be longer than five inches long. In some implementations, the container 102 may be one inch to two inches wide. In some implementations, the container 102 may be smaller than one inch wide. In some implementations, the container 102 may be larger than two inches wide.

In some implementations, the lid 108 is configured to cover the open enclosure 114. In some implementations, the lid 108 is configured to keep the content in the container 102 from spilling out of the container 102 on one end.

In some implementations, the lid 108 is a removable cover. In some implementations, the lid 108 is configured to engage at least a rim 102a of the container 102 so that the lid 108 may be fixedly attached to the container 102. In some implementations, the lid 108 is a screw closure. For example, in some implementations, the lid 108 may be configured to be screwed onto or off the container 102. More specifically, in some implementations, the lid 108 may comprise threads 116 and the container 102 may comprises threads 118. In some implementations, lid 108 may be screwed onto or off the container 102 by a mating engagement or disengagement respectively of the threads 116, 118. In some implementations, the lid 108 may be any suitable closure type.

In some implementations, each of the hollow elongated projections 104 comprises a proximal end 110 and a distal end 112 with an opening extending from the proximal end 110 to the distal end 112. In some implementations, the distal end 112 may be pointed. In this way, the distal end 112 of the projections 104 may be inserted into meat.

In some implementations, the hollow elongated projections 104 extend from opening 102b in the bottom surface of the container 102. In this way, liquid content contained in the container 102 can flow from the container 102, though an opening in the proximal end 110 of the projections 104, through the interior of the projections 104, and out of an opening in the distal end 112 of the projections 104. In some implementations, the hollow elongated projections 104 are aligned lengthwise along the bottom surface of the container 102.

In some implementations, there may be three to seven hollow elongated projections 104 aligned lengthwise along the bottom surface of the container 102. In some implementations, there may be less than three elongated projections 104 aligned lengthwise along the bottom surface of the container 102. In some implementations, there may be more than seven hollow elongated projections 104 aligned lengthwise along the bottom surface of the container 102.

In some implementations, the hollow elongated projections 104 may be two inches to three inches long. In some implementations, the hollow elongated projections 104 may be shorter than two inches long. In some implementations, the hollow elongated projections 104 may be longer than three inches long.

In some implementations, the meat flavor injector 100 or components of the meat flavor injector 100 may be composed of a metal. In some implementations, the meat flavor injector 100 or components of the meat flavor injector 100 may be composed of any other suitable material.

In some implementations, the meat flavor injector 100 may be used to inject moisture and/or flavor into a meat during the cooking process. In some implementations, the meat may be at least a portion of poultry, beef, pork, or other meat. In some implementations, the meat flavor injector 100 may be used with any other food item. In some implementations, the meat flavor injector 100 may be used while the meat or other food item is being baked, roasted, or broiled.

In some implementations, to use the meat flavor injector 100 according to an implementation of the present disclosure, content may be inserted into the container 102 of the meat flavor injector 100. In some implementations, the content may be inserted into the container 102 by first separating the lid 108 from the container and inserting the contents into the opening 114.

In some implementations, the content may be a liquid, solid, or combination of both. In some implementations, contents may comprise water, butter, garnishes, a marinade, or any other liquid, seasoning, or ingredients.

In some implementations, once the contents are inserted into the container 102, the lid 108 may be secured to the container 102 to hold the contents in the container 102.

In some implementations, the distal ends 112 of the hollow elongated projections 104 are inserted into the meat. In some implementations, the hollow elongated projections 104 are inserted into the meat so that the contents can flow from the container 102 through the hollow elongated projections 104 into the meat. In some implementations, the hollow elongated projections 104 are inserted into the meat while the meat is cooking.

Reference throughout this specification to “an embodiment” or “implementation” or words of similar import means that a particular described feature, structure, or characteristic is included in at least one embodiment of the present invention. Thus, the phrase “in an embodiment”, “in some implementations”, or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail . . .

1. A meat flavor injector comprising:
a container comprising an outer surface defining an open enclosure for holding content placed in the container;
a lid configured to cover the open enclosure to keep the content in the container from spilling out of the container on one end; and
a plurality of hollow projections extending from the container wherein each of the hollow elongated projections comprises a proximal end and a distal end with an opening extending from the proximal end to the distal end and wherein distal of ends of the hollow elongated projections are pointed.

2. The meat flavor injector of claim 1 wherein the container is cylindrical.

3. The meat flavor injector of claim 1 wherein the lid is configured to engage at least a portion of the container so that the lid may be fixedly attached to the container.

4. The meat flavor injector of claim 3 wherein the lid is a screw closure where the lid comprises threads and the container comprises threads so that the lid may be screwed on and off the container.

5. The meat flavor injector of claim 1 wherein the plurality of hollow projections are aligned lengthwise along the bottom surface of the container.

6. A method of using the meat flavor injector of claim 1, the method comprising:
inserting content into the opening of the container; and
inserting the distal ends of the plurality of hollow projections into a portion of meat.

7. The method of claim 6 further comprising securing the lid to the container to hold the contents in the container.

8. The method of claim 7 wherein the content comprises a liquid and seasoning.
